(19) United States
(12) Patent Application Publication
(10) Pub. No.: US 2009/0094771 A1
(43) Pub. Date: Apr. 16, 2009

(54) Digital Single Lens Reflex Camera And Lens Cleaner

(76) Inventor: Ross Wordhouse, Bend, OR (US)

Correspondence Address: PERKINS COIE LLP, P.O. BOX 1208, SEATTLE, WA, 98111-1208, US

(21) Appl. No.: 11/873,304

(22) Filed: Oct. 16, 2007

(51) Int. Cl. B08B 11/04

(52) U.S. Cl. 15/214; 396/429

(57) ABSTRACT

A cleaning device for removing foreign particles off of a digital single lens reflex (DSLR) camera and lenses exposed optic surfaces including a hand held application wand, a cohesive rubber and a cleaning base pivoting joint. The user may hold the application wand by the finger grip and align the pivoting base angle to reflect the angle of the optic surface that's about to be cleaned. The next step would be to insert the wand base and cohesive onto the desired optic surface to be cleaned. The rubber would be pressed down onto the sensor filter and adhere any foreign particles to it. The wand and rubber would then be removed by manually lifting up on the wand. The cleaning rubber layer is specially designed and manufactured to leave substantially no residue or contamination on the optic surfaces.

### BACKGROUND OF THE INVENTION

This invention relates to digital single lens reflex (DSLR) cameras and lenses. More specifically this invention relates to the safe removal of foreign particles that accumulate on the internal mirror, focusing screen, and imaging sensor filter found within a DSLR camera. The present invention also relates to the safe removal of foreign particles from the exposed and hard to reach internal rear optic element found within a camera lens. A function of this invention is to remove dust and particles without causing residue or damage to the mirror, focusing screen, sensor filter and rear element lens optic.

### DESCRIPTION OF THE PRIOR ART

DSLR camera sensor filters are most often cleaned by several means, e.g., electrostatic brush, sterile swab and liquid, rubber or polyurethane and hand held air puffers. Most of these systems don't function at a performance level that is desirable and leave many foreign particles and residue on the surfaces after cleaning. The brush and the swab cleaning method uses a dragging motion to remove the dust which might scratch the surfaces during the cleaning process. Also, both the brush and the swab method use parts that cannot pass FAA security check points for airline passenger boarding. The brush uses canned air that can not be taken on a plane by any means and the swab uses flammable liquid that cannot be carried aboard the passenger compartment of a commercial airliner. Many traveling photographers do not like being separated from their camera equipment due to its high cost and fragile nature. So, the ability to offer a device which can be carried on board an airliner is much desired.

None of the above mentioned cleaning devices are suitable to clean a camera's internal mirror and focus screen. These two additional imaging surfaces have been overlooked by many cleaners due to their awkward angle and position. Another surface that has been overlooked is the exposed rear optic element found within telephoto lenses. This optic surface can be recessed as much as an inch within the body of the lens, making it very hard to clean. A technique that can clean all four imaging surfaces is much desired.

Molded rubber and polyurethane cleaners are afflicted with the problem of mold release agents being impregnated onto their surfaces after molding. These mold release agents can leave residue on the optic filters after cleaning. A solution that does not leave residue is much desired.

Molded rubber, more specifically molded EPDM and silicone cleaners, like the one found in patent application USP 20060127083, have a tendency to leave mold release residue behind on cleaned optical surfaces due to the manufacturing techniques used to create the molded part. Those skilled in the art know that a mold is needed to create a rubber cleaner that is the same size and R arc shaped which is called out in the above mentioned patent application. The mold requires a mold release agent to coat the sides of the mold so the part can be ejected after molding. During the molding process the mold release agent is impregnated into the sides of the rubber and is virtually impossible to remove. When the rubber cleaner is used it can transfer the impregnated mold release agent residue to the optical surfaces to be cleaned. The applicant believes this to be a major oversight and will lead to images being degraded due to mold release residue remaining on the camera's imaging sensor filter after cleaning.

The rubber cleaner found in patent application USP 20060127083 uses an R arc shape on the cleaning surface of the part to help eliminate a vacuum seal when it's applied to an imaging surface. This arc requires the user to rock the rubber cleaner back and forth to make sure the cleaner has contacted the entire cleaning surface. This rocking is easy to overlook and could cause an improper cleaning.

The rubber cleaner found in patent application USP 20060127083 and all other above mentioned sensor filter cleaners are not designed to clean a camera's internal mirror, focusing screen and a rear optical lens element.

The rubber cleaner found in patent application USP 20060127083 and all other above mentioned sensor filter cleaner wands and holding devices are not designed to allow the sight path of the user to see the entire cleaning surface when in use. The users hands obstruct much of the field of view when the device is inserted into the internal workings of a digital camera.

### SUMMARY OF THE INVENTION

The present invention teaches, among other things, a cleaning device for substantially removing foreign particles from a sensor filter, mirror and focusing screen found within the internal workings of a functioning DSLR camera. Certain embodiments of the present invention provide the combination of two main elements, an application wand and a pivoting cleaning base to create an easy to use and safe hand operated camera cleaning device that can be used multiple times for the removal of foreign particles. According to other embodiments, an extruded LSR surface used to remove the foreign particles leaves substantially no residue or contamination after application. According to another aspect of the present invention, a micro texture is used on the LSR surface to substantially eliminate a vacuum effect on the imaging surface when cleaned.

Yet another aspect of the present invention is a pivoting cleaning base which allows the cleaner to be used to clean additional angled optical surfaces within a digital camera. The present invention also teaches an application wand design, having a finger grip that offsets the user's fingers allowing a user a clearer sight path of the sensor filter and easier application by the user. Other embodiments teach a cleaning base shaped like a square for cleaning rectangle imaging surfaces, a circle for cleaning lens optics and a combined half square/half circle to be a multi tasking cleaning base apparatus.

According to another aspect, the present invention teaches using a cleaning device that uses a hand held motion of up and down during the cleaning process which would exclude the possible sensor scratching due to the dragging method of the brush and swab. In order to adhere the foreign particles to this new cleaning device an extruded and textured liquid silicone rubber (LSR) is being utilized. This extruded and textured LSR has been specifically designed for optic applications and will not leave contamination or residue after application do to it not using traditional molds in it creation. This device is also designed to have a pivoting cleaning head in order to have the proper angles to clean the multiple optic surfaces within a camera and lens. This cleaning device consists of two main elements, the hand operated application wand and the pivoting base that holds the extruded LSR. In certain embodiments, the device does not use anything that is considered contraband by the FAA and can be brought aboard the passenger compartment of a commercial airliner.

### DESCRIPTION OF THE DRAWINGS

FIG. 1 is a side view of a cleaning device.

FIG. 2 is a side view of the cleaning device with the cleaning base removed.

FIG. 3 is a side view of the cleaning device with the cleaning base removed.

FIG. 4 is a top view of different possible shapes of a cleaning base.

FIG. 5 is a cross section view of the cleaner cleaning a camera mirror.

FIG. 6 is a cross section view of the cleaner cleaning a camera focus screen.

FIG. 7 is a cross section view of the cleaner cleaning a camera sensor filter.

FIG. 8 is a cross section view of the cleaner cleaning a camera lens rear optical element.

### DRAWING REFERENCE NUMERALS

1 Finger Grip

2 Stem

3 Pivot Arm

4 Pivot Socket Base

5 Extruded LSR

6 Base shaped like a circle

7 Base shaped like a combined square and circle

8 DSLR Camera

9 Focus Screen

10 Mirror

11 Sensor Filter

12 CCD/CMOS Imaging chip

13 Cleaning Device

14 Camera Lens

15 Optic elements of a lens

16 Rear optic element of a lens

17 Cleaning Base

18 Application Wand

### DESCRIPTION OF THE PREFERRED EMBODIMENT

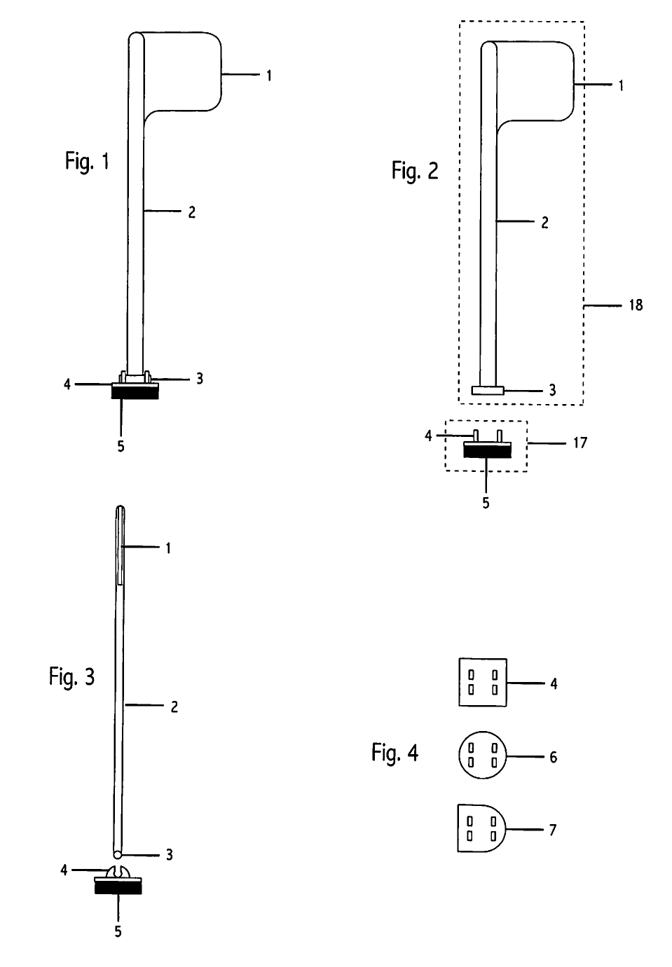

A cleaning device made up of two main elements is shown in FIGS. 1-2 according to one embodiment of the present invention. The cleaning device of FIG. 2 includes an application wand 18 and a cleaning base 17. The wand 18 attaches to the cleaning base 17 by inserting a wand pivot arm 3 into a pivot socket base 4. The application wand 18 and the cleaning base 17 is used together, as described below in more detail, for the sensor, lens, mirror and focus screen cleaning.

The application wand 18 has a finger grip 1 which is located at the top of the wand 18 and protrudes on one side which runs parallel to the connecting joint of the pivot socket base 4. The stem 2 connects the finger grip 1 to the pivot arm 3. The pivot arm 3 is connected to the cleaning base 17 by the means of a pivot socket base 4. The extruded SLR 5 is adhered to the pivot socket base 4 with adhesive.

The application wand 18 can be made of any suitable material and by any suitable mechanism, e.g., in one embodiment the application wand 18 is injection molded plastic but could also be made of wood or metal. According to one specific embodiment of FIG. 2, the application wand 18 measures about 15/16″ wide and about 3.5″ high. This wand size offers suitable controllability but could be made larger or smaller. In another embodiment, the cleaning base surface 17 measures about 12 mm by about 12 mm. This is a suitable size enabling cleaning of multiple sizes of sensor filters, mirrors and focusing screens. The cleaning base 17 can also be deigned using multiple shapes like squares 4, circles 6 and circle/square blends 7, as shown in FIG. 4.

An extruded LSR 5 can take any suitable form, such as a 3 mm thick, textured liquid silicone rubber sheet called Bisco made by Rogers Incorporated. It has a durometer of 10a and has a very fine micro texture on its surface. The manufacturing of this extruded product uses a platinum cure technique which does not create any by-products when cured, making it suitable for optic applications. One feature of the Bisco LSR is that it uses no mold release agents in its creation which can contaminate optic surfaces, has a micro texture that does not allow the silicone to vacuum adhere to optic surfaces, has a cushioning effect when a user depresses the device onto optic surfaces, and removes dust particles without leaving oily residue. The use of different extruded rubbers, textures, thicknesses and durometers could be implemented. In certain embodiments these products would have attributes similar with the Bisco LSR.

Through known converting techniques the LSR can be die cut into the desired extruded LSR shape and adhered to the pivot socket bases 4 using adhesives. Once assembled, the cleaning device will be placed within a clean zip lock bag (not shown).

### OPERATION OF THE INVENTION

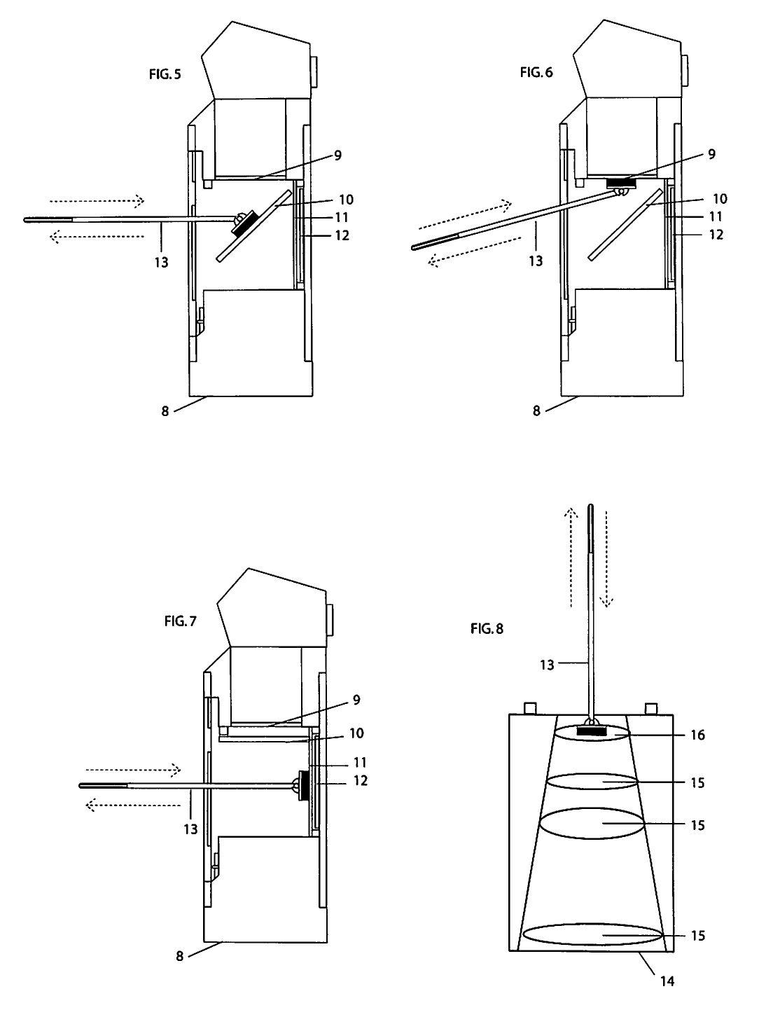

A method of operation of the invention according to one embodiment will now be described with reference to FIGS. 5-8. In use, the user would expose the cleaning device from the plastic bag (not shown) and angle the top of the pivot socket base 4 with their fingers parallel to the desired surface to be cleaned, making sure not to touch the extruded LSR 5. The user would then position their fingers on the finger grip 1 and move the application wand 13 onto the internal optic surface of a camera 8 to be cleaned, e.g., in FIG. 5 the optic surface being a mirror 10. The user would look down the shaft 2 of the application wand 13 and align one corner of the cleaning base 5 with the a corner of the mirror 10. The user would move the cleaning base 5 and wand 13 by hand onto the mirror and apply a gentle force that would condense the texture on the cleaning rubber 5. This would insure that substantially the entire surface of the rubber 5 came into contact of the mirror 10. Then the user would lift the wand 10 and release the rubber, capturing substantially any dust particles from the mirror surface on the cohesive extruded LSR 5. The user would repeat the process until the mirror 10 is substantially clean. Once the user has finished cleaning they will remove the wand 13 from the camera 8 and clean the now dirty LSR 5 by applying the LSR cleaning surface to a light tack tape (not pictured). Bisco LSR, for example, has difficulty adhering to low tack adhesives so when LSR is applied to the tape, the tape will attach to the dust contamination. When the SLR is removed the contamination will remain on the tape, making the device ready to clean a next optical surface. Due to the properties of the LSR, adhesive from the tape will not transfer to the cleaning surface of the LSR. The user can repeat the process for cleaning camera 8 focus screens 9, see FIG. 6, sensor filters 11, see FIG. 7, and exposed optical elements 15 and 16 of lenses 14, see FIG. 8. The rubber has the ability to remove the dust particles due to the softening oils contained within it. The cleaning base 17 could be formed with an optional pivoting base. As a result, a user has one device that can clean multiple internal optic surfaces by just rotating the cleaning base angle 17. Once finished cleaning, the application wand 13 can be stored in a clean zip lock bag (not shown) and maintained for future camera component cleaning.

While these and other features of the invention have been described by reference to the preferred embodiments, those skilled in the art will recognize that the invention can be varied in manufacturing, arrangement and detail without departing from the scope of the invention.

1. A tool for manual use by a user in removing particles from internal and exposed optic surfaces in a digital single lens reflex camera, said tool comprising:
a supporting member which can be supported by the user;
a resilient member attached to a first side of said support member, said resilient member being positioned for optic surface contact; and
a pivoting member placed between said support member and said resilient member.

2. A tool as recited in claim 1 wherein a length and/or a width dimension of said resilient member is between about 10 mm and about 17 mm, and said resilient member is shaped as one of a square, a rectangle, a circle, or a combination shape.

3. A tool as recited in claim 1 wherein said resilient member includes extruded liquid silicone rubber.

4. A tool as recited in claim 1 wherein said resilient member includes a micro texture on a first surface.

5. A tool as recited in claim 1 wherein cleaning using said resilient member tends to produce a residue-free optic surface due to the absence of mold release agents used when curing said resilient member.

6. A tool as recited in claim 1 wherein said pivot member angle can be adjusted by hand to align with multiple internal optical surfaces for cleaning thereof.

7. A tool as recited in claim 1 wherein said support member is further comprised of an upper elongate portion having a central longitudinal axis, and a gripping portion offset from said central longitudinal axis.

8. A tool for removing particles as recited in claim 1 wherein said pivoting member comprises a lower surface for receiving said resilient member and an upper elongate portion and an upper surface for coupling with said support member.

9. A tool for a user manually removing particles from internal and exposed optic surfaces of a camera, said tool comprising:
a cylindrical supporting member which is supported by the user;
and a resilient member attached to a first side of said support member which is cohesive and positioned for optic surface contact.

10. A tool as recited in claim 8 wherein length and width of the resilient member are between about 10 mm and about 17 mm, and said resilient member is shaped as either a square, rectangle, circle or a combination thereof.

11. A tool as recited in claim 8 wherein said resilient member comprises extruded liquid silicone rubber.

12. A tool as recited in claim 8 wherein said resilient member comprises a micro texture on a first surface.

13. A tool as recited in claim 8 wherein cleaning using said resilient member tends to produce a residue-free optic surface due to the absence of mold release agents used when curing said resilient member.

14. A tool as recited in claim 8 wherein said support member is further comprised of an upper elongate portion having a central longitudinal axis, and a gripping portion offset from said central longitudinal axis.

15. A tool as recited in claim 8 wherein said support member comprises a lower surface for receiving said resilient member and an upper elongate portion.

16. A tool as recited in claim 1, wherein said supporting member is cylindrical.

17. A tool for manual use by a user in removing particles from internal and exposed optic surfaces in a digital single lens reflex camera, said tool characterized in that a cleaning surface of the tool tends not to leave residue on said optic surfaces, and said cleaning surface may be manually adjusted to different positions, each different position suited for cleaning a different optic surface.
